(19) United States
(12) Patent Application Publication
(10) Pub. No.: US 2017/0284329 A1
(43) Pub. Date: Oct. 5, 2017

(54) INTERNAL COMBUSTION ENGINE

(71) Applicant: TOYOTA JIDOSHA KABUSHIKI KAISHA, Toyota-shi, Aichi (JP)

(72) Inventors: Takeshi ASHIZAWA, Yokohama-shi (JP); Yuta OCHI, Susono-shi (JP)

(73) Assignee: Toyota Jidosha Kabushiki Kaisha, Toyota-shi, Aichi (JP)

(21) Appl. No.: 15/508,590

(22) PCT Filed: Aug. 21, 2015
(86) PCT No.: PCT/JP2015/004212

§ 371 Date: Mar. 3, 2017

(30) Foreign Application Priority Data
Sep. 4, 2014 (JP) 2014-179904

(51) Int. Cl. F02D 41/30; F02D 41/40; F02B 23/10

(52) U.S. Cl. CPC F02D 41/3047; F02B 23/101; F02D 41/403; F02B 2023/108; F02D 2041/389

(57) ABSTRACT

An object is to enable stable diesel combustion in an internal combustion engine using a fuel having a relatively high self-ignition temperature. In the internal combustion engine, pre-injection and ignition of pre-spray fuel are performed, and thereafter main injection is performed to cause a portion of main-injected fuel to be burned by diffusion combustion. Injection ports of a fuel injection valve are provided in such a way that the quantity of the main injected fuel injected to a predetermined region defined by a predetermined angle equal to or smaller than 90 degrees about the fuel injection valve from the location of an ignition device in the direction of rotation of the swirl is relatively small.

### TECHNICAL FIELD

The present invention relates to an internal combustion engine.

### BACKGROUND ART

What is called diesel combustion, in which fuel is directly injected into compressed air in the combustion chamber, self-ignites, and is burned by diffusion combustion, is advantageous over spark-ignition combustion in its excellent thermal efficiency. While fuel generally used in diesel combustion is light oil having a relatively low self-ignition temperature, patent literature 1, for example, discloses a technology of diesel combustion using natural gas having a relatively high self-ignition temperature as fuel. Specifically, fuel injection (pre-injection) is performed in a predetermined region in the combustion chamber in an early or middle stage of the compression stroke, and the air-fuel mixture formed in the aforementioned region is ignited at a time just before the top dead center of the compression stroke, to establish a high-temperature, high-pressure condition enabling self-ignition of natural gas in the combustion chamber. In addition, fuel injection (main injection) for diffusion combustion is performed in the combustion chamber in a high-temperature, high-pressure condition after the top dead center of the compression stroke.

### CITATION LIST

### Patent Literature

### [PTL 1] Japanese Patent Application Laid-Open No. 2003-254105

### [PTL 2] Japanese Patent Application Laid-Open No. 2002-097960

### [PTL 3] Japanese Patent Application Laid-Open No. 2008-267318

### SUMMARY OF INVENTION

### Technical Problem

In the region in the combustion chamber in which fuel injected by the pre-injection is burned, oxygen is consumed by combustion. If fuel is injected into this region by the main injection, oxygen required to burn the fuel injected by the main injection would be insufficient. Consequently, the combustion condition of the fuel injected by the main injection would be deteriorated, possibly leading to the generation of smoke.

The present invention has been made in view of the above-described problem, and an object of the present invention is to enable stable diesel combustion in an internal combustion engine using a fuel having a relatively high self-ignition temperature.

### Solution to Problem

To solve the above problem, according to the present invention, there is provided an internal combustion engine having a combustion chamber in which a swirl or swirling flow about the center axis of its cylinder is generated, comprising: a fuel injection valve having a plurality of injection ports and injecting fuel in directions from the center axis of the cylinder toward the wall of the cylinder; an ignition device whose position relative to said fuel injection valve is set in such a way that fuel spray injected through said fuel injection valve passes through an ignition-capable region and the ignition device can ignite the fuel spray directly; a controller configured to perform pre-injection, which is fuel injection performed through said fuel injection valve during the compression stroke, ignite pre-spray, which is fuel spray formed by the pre-injection, by said ignition device, and thereafter perform main injection, which is fuel injection through said fuel injection valve performed at such a predetermined injection start time before the top dead center of the compression stroke that enables combustion to be started by flame of pre-injected fuel, thereby causing at least a portion of main-injected fuel to be burned by diffusion combustion,

wherein said fuel injection valve has a plurality of injection ports provided in such a way that the quantity of said main-injected fuel injected to a predetermined region that is defined by a predetermined angle equal to or smaller than 90 degrees about the fuel injection valve from the location of the ignition device in the direction of rotation of the swirl is smaller than the quantity of said main-injected fuel injected to a region that is located adjacent to or apart from said predetermined region in the direction of rotation of the swirl, does not include the predetermined region, and is defined by an angle equal to said predetermined angle to have the same size as said predetermined region.

In this internal combustion engine, pre-injection is performed prior to main injection that mainly determines the power of the internal combustion engine, and the fuel injected by the pre-injection (which will be hereinafter referred to as the “pre-injected fuel”) is spark-ignited, so that a portion of the pre-injected fuel remains unburned and is subjected to diesel combustion together with the fuel injected by the main injection (which will be hereinafter referred to as the “main-injected fuel”). By performing the pre-injection and the main injection in this way, a condition suitable for diesel combustion of the main-injected fuel is established in the combustion chamber at the time of main injection, and it is possible for a portion of the pre-injected fuel to contribute to the power of the internal combustion engine. In consequence, the thermal efficiency can be improved. It should be noted that the words “pre” and “main” in the context of the present invention qualify injections only in terms of their temporal priority and posteriority, and these words should not be construed in any limited sense other than the technical meaning described in the following.

The position of the ignition device relative to the fuel injection valve is set in such a way that the ignition device can directly ignite passing fuel spray, which is fuel spray injected through the fuel injection valve and passing through the ignition-capable region. The relative positional relationship between the ignition device and the fuel injection valve is not limited to the relationship in which an injection port of the fuel injection valve is oriented to the ignition device or the relationship in which the center of fuel spray passes through the ignition-capable region. It may also be the case that no injection port of the fuel injection valve is oriented to the ignition device, but a portion of fuel spray enters the ignition-capable region. It is generally the case that air-fuel mixture is brought to the ignition-capable region of the ignition device by means of gas flow formed in the combustion chamber according to the target combustion form when the intake valve is opened or the shape of a cavity or the like located on top of the piston, so that the fuel spray is ignited. In such a generally employed mode of ignition, the injection time at which injection through the injection valve is to be performed is greatly dependent on the opening time of the intake valve and the position of the piston in the cylinder and other factors. In contrast to this, in the internal combustion engine according to the present invention, since the relative position of the fuel injection valve and the ignition device is set relative to each other as described above, control of the fuel injection time and the ignition time has very high flexibility, enabling control of fuel injections. Preferably, the ignition device is adapted to be capable of directly igniting the passing fuel spray injected through the fuel injection valve at desired time without regard to the opening time of the intake valve and the piston position of the internal combustion engine.

In the present invention, firstly, the pre-injection is performed during the compression stroke, and pre-spray is ignited by the ignition device. Thereafter, the main injection is performed at a predetermined injection start time before the top dead center of the compression stroke, so that self-ignition diffusion combustion is brought about. The main injection is fuel injection performed in such a way that combustion is started by flame of the pre-injected fuel. Thus, correlation between the pre-injection and the main injection is controlled so that the main-injected fuel is ignited by flame generated by ignition and combustion of the pre-injected fuel and self-ignition diffusion combustion is brought about subsequently. The time at which the pre-injection is performed may be determined taking into consideration the correlation with the main injection so that self-ignition diffusion combustion can be brought about after the main injection.

It has been discovered that performing the pre-injection and the main injection in the above-described manner can achieve stability in combustion and improvement in the thermal efficiency of the internal combustion engine, which cannot be achieved by conventional arts. One of the reasons why such combustion stability and improvement in the thermal efficiency can be achieved is considered to be that with the above-described correlation of the pre-injection and the main injection, a high-temperature, high-pressure condition is established in the combustion chamber at the time of injection of the main-injected fuel by the combustion of the pre-injected fuel and a portion of the pre-injected fuel self-ignites and is burned by diffusion combustion together with the main-injected fuel to contribute to the engine power efficiently. The reason why combustion stability and improvement in the thermal efficiency of the internal combustion engine can be achieved by the present invention is not limited to the above-described reason, and all the internal combustion engines that are based on the above-described technical idea falls within the scope of the present invention even if combustion stability and improvement in the thermal efficiency are achieved for other reasons.

In the region in which burned gas of the pre-injected fuel is present (which will be hereinafter referred to as the burned gas region), the oxygen concentration has been lowered by the combustion of the pre-injected fuel, and there is a possibility that the quantity of oxygen is not sufficient for combustion of the main-injected fuel. For this reason, if main injection is directed to the burned gas region, there is a possibility that the combustion condition of the main-injected fuel may be deteriorated in the burned gas region. If the quantity of the main-injected fuel injected to the predetermined region defined by a predetermined angle equal to or smaller than 90 degrees about the fuel injection valve from the location of the ignition device in the direction of rotation of the swirl is made relatively small, deterioration of the combustion condition due to insufficiency of oxygen can be reduced. Since there is a swirl in the combustion chamber, the burned gas region is carried by the swirl. In other words, the burned gas region shifts in the direction of rotation of the swirl during the time period from the ignition of the pre-injected fuel until the start of the main injection. In the internal combustion engine according to the present invention, the positions or the shapes of the injection ports of the fuel injection valve are designed in such a way that fuel injected by the main injection is unlikely to reach the region to which the burned gas region can be shifted or carried by the effect of the swirl. At the time when the main injection is performed, it is considered that the burned gas region has shifted in the direction of rotation of the swirl from the location of the ignition device. Therefore, the range of the aforementioned predetermined angle may be set to extend from the ignition device. The swirl whirls about the center axis of the cylinder, but it is not necessary that the center axis of the swirl and the center axis of the cylinder are precisely aligned with each other. Moreover, it is not necessary that the center axis of the swirl and the center axis of the fuel injection valve are precisely aligned with each other. Still further, it is not necessary that the center axis of the cylinder mentioned in the context of the present invention is located at the center of the cylinder in the strict sense. For example, the center axis of the cylinder may be an axis located in the central region in the cylinder as seen from above and extending in the direction along which the piston reciprocates vertically. In other words, what is essential is that the center axis of the cylinder is located in the central region.

In the internal combustion engine according to the present invention, said predetermined region may be a region in the combustion chamber in which burned gas of said pre-injected fuel is expected to exist at the time when said main injection is performed after the burned gas of said pre-injected fuel has been carried by the swirl. The predetermined region may be a region in which the burned gas of the pre-injected fuel exists after the burned gas has been carried by the swirl. The predetermined region relates to the injection interval between the pre-injection and the main injection, and it can be said that the predetermined region is a region in which a large quantity of burned gas of the pre-injected fuel exists at the time when the main injection is performed. The aforementioned predetermined region may be a region over which the burned gas region extends or a region over which the burned gas region can extend. The predetermined angle is an angle about the fuel injection valve from the location of the ignition device in the direction of rotation of the swirl, and this angle may be an angle over which the burned gas is expected to extend. The predetermined angle is an angle about the fuel injection valve from the location of the ignition device in the direction of rotation of the swirl, and this angle may be an angle over which the burned gas region extends or can extend. The plurality of injection ports of the fuel injection valve are provided taking into consideration the predetermined region.

The expression “the quantity of said main-injected fuel injected to a predetermined region that is defined by a predetermined angle equal to or smaller than 90 degrees about the fuel injection valve from the location of the ignition device in the direction of rotation of the swirl is smaller than the quantity of said main-injected fuel injected to a region that is located adjacent to or apart from said predetermined region in the direction of rotation of the swirl, does not include the predetermined region, and is defined by an angle equal to said predetermined angle to have the same size as said predetermined region” shall be construed to include a case where the main-injected fuel is not injected to the predetermined region at all.

By making the quantity of the main-injected fuel injected to the predetermined region relatively small, it is possible to prevent insufficiency of oxygen available for combustion of the main-injected fuel. Therefore, it is possible to prevent deterioration of the combustion condition and to improve the thermal efficiency.

In the internal combustion engine according to the present invention, said fuel injection valve may have no injection port that injects said main-injected fuel toward said predetermined region at the time of said main injection.

In other words, the injection ports may be provided in such a way that no injection ports of the fuel injection valve are oriented toward the predetermined region at the time of the main injection. Since the burned gas region shifts in the direction of rotation of the swirl, the injection port having injected the fuel constituting the source of the burned gas region is no longer facing the burned gas region at the time of the main injection. Therefore, the main-injected fuel injected by the injection port having injected the fuel constituting the source of the burned gas region can burn with a sufficient amount of oxygen. On the other hand, there is a possibility that injection ports located downstream of the injection port having injected the fuel constituting the source of the burned gas region with respect to the direction of rotation of the swirl may be facing the burned gas region at the time of the main injection. If the injection ports of the fuel injection vale are arranged at regular intervals (or regular angular intervals) about the center axis of the fuel injection valve, there is a possibility that fuel injected by an injection port(s) located downstream of the injection port having injected the fuel constituting the source of the burned gas region with respect to the direction of rotation of the swirl may enter the burned gas region.

If there is no injection port that faces the predetermined region (or the burned gas region) at the time of the main injection, the main-injected fuel can be prevented from entering the burned gas region, and combustion of the main-injected fuel can be promoted. Consequently, deterioration of the combustion condition of the main-injected fuel can be prevented.

In the internal combustion engine according to the present invention, the size of an injection port of said fuel injection valve that injects said main-injected fuel toward said predetermined region at the time of said main injection may be smaller than the size of an injection port of said fuel injection valve that injects said main-injected fuel toward a region other than said predetermined region at the time of said main injection.

In other words, the size of an injection port that faces the predetermined region may be smaller than the size of an injection port that does not face the predetermined region. If the fuel pressure is the same, the smaller the size of an injection port is, the smaller the quantity of fuel injected through it is. Therefore, if the size of an injection port that faces the predetermined region is relatively small, the quantity of the main-injected fuel that reaches the predetermined region (or the burned gas region) can be made relatively small.

Since the quantity of the main-injected fuel entering the burned gas region is made small in this way, combustion of the main-injected fuel can be promoted. Therefore, deterioration of the combustion condition of the main-injected fuel can be prevented.

The internal combustion engine according to the present invention may have a swirl control valve provided in an intake passage of the internal combustion engine and capable of increasing the speed of the swirl in the cylinder of the internal combustion engine by decreasing the degree of opening, and the higher the engine speed of the internal combustion engine is, the larger the degree of opening of said swirl control valve may be made.

The speed of the swirl can change depending on the engine speed of the internal combustion engine. The higher the engine speed is, the higher the speed of the intake air flow is, and the higher the speed of the swirl can be. Changes in the speed of the swirl lead to changes in the distance of shift of the burned gas region after the formation of the burned gas region by combustion of the pre-injected fuel until the start of the main injection. The intervals between the injection ports of the fuel injection valve or the sizes of the injection ports cannot be changed in the state in which the fuel injection valve is mounted in the internal combustion engine. If the injection ports are designed taking into consideration the position of the burned gas region in the entire operation range, the quantity of the pre-injected fuel and the quantity of the main-injected fuel become small in a large range. In view of the above, it is possible to keep the speed of the swirl constant irrespective of the engine speed of the internal combustion engine. For this purpose, the internal combustion engine according to the present invention may be adapted to control the speed of the swirl by the swirl control valve. When the degree of opening of the swirl control valve is decreased, the speed of the swirl increases due to an increase in the degree of unevenness in the intake air flowing into the combustion chamber and an increase in the speed of the intake air flow. In contrast, when the degree of opening of the swirl control valve is increased, the speed of the swirl decreases due to a decrease in the degree of unevenness in the intake air flowing into the combustion chamber and a decrease in the speed of the intake air flow. Therefore, the higher the engine speed of the internal combustion engine is, the larger the degree of opening of the swirl control valve may be made. By this control, the speed of the swirl can be kept constant irrespective of the engine speed of the internal combustion engine. In consequence, the distance of shift of the burned gas region can be prevented from changing, and the main-injected fuel can be prevented from entering the burned gas region.

### Advantageous Effects of Invention

The present invention can enable stable diesel combustion in an internal combustion engine using a fuel having a relatively high self-ignition temperature.

### BRIEF DESCRIPTION OF DRAWINGS

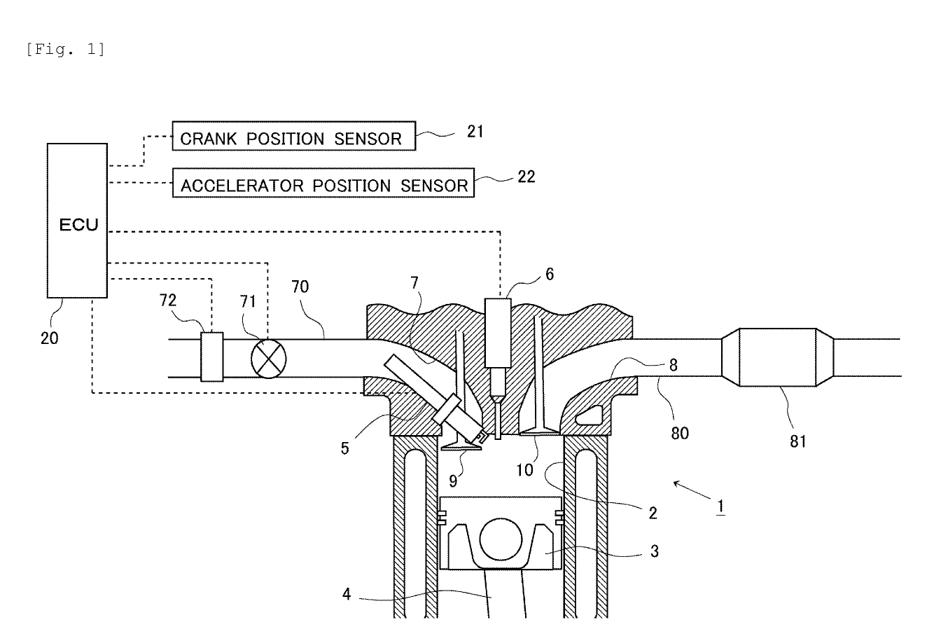

### [FIG. 1]

FIG. 1 is a diagram showing the general configuration of the air-intake and exhaust systems of an internal combustion engine to which an embodiment of the present invention is applied.

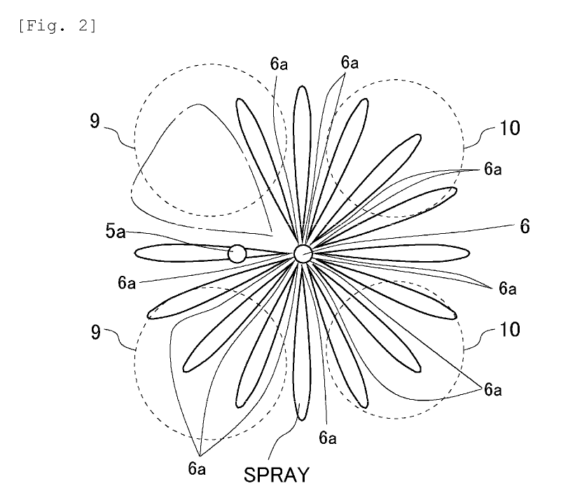

### [FIG. 2]

FIG. 2 is a diagram showing how fuel is sprayed from the fuel injection valve according to example 1.

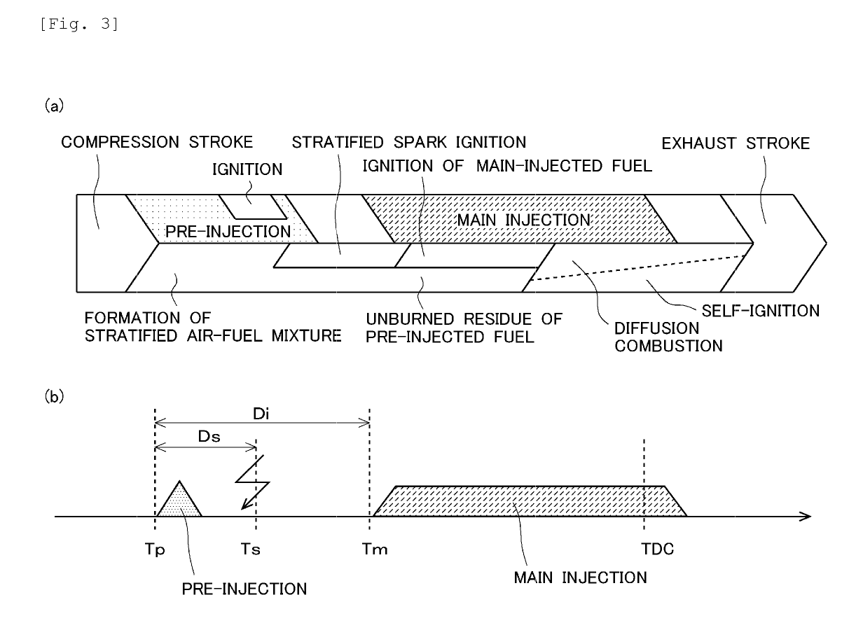

### [FIG. 3]

FIG. 3 is a diagram illustrating combustion control performed by a control apparatus of an internal combustion engine according to an example of the present invention (which will be hereinafter referred to as the “combustion control according to the present invention”).

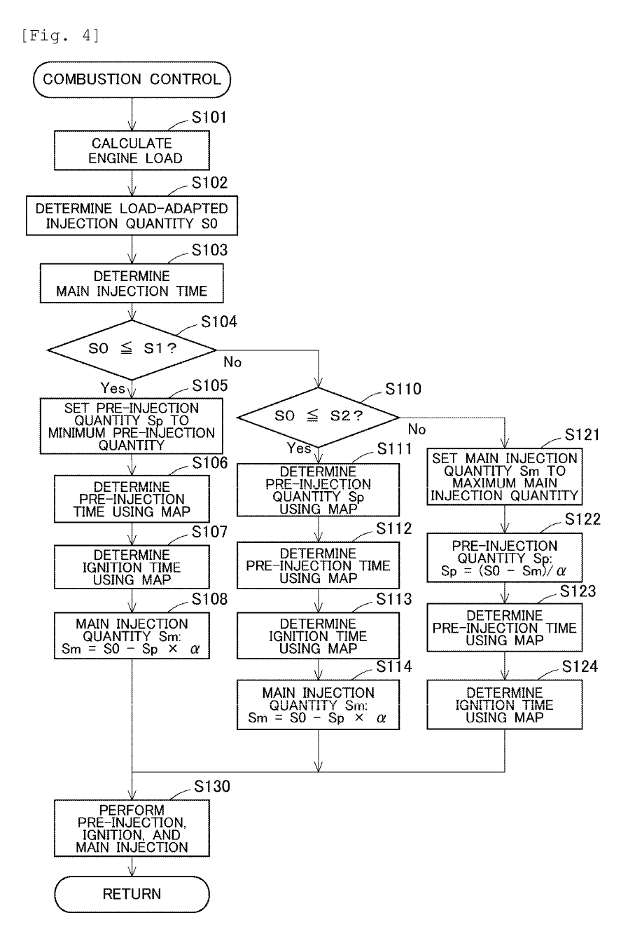

### [FIG. 4]

FIG. 4 is a flow chart of the combustion control according to the present invention performed in the internal combustion engine shown in FIG. 1.

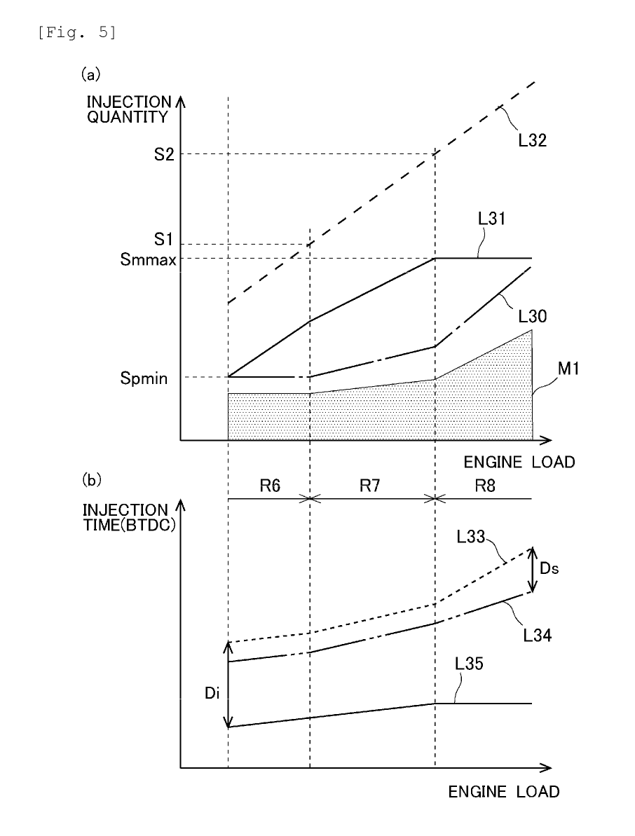

### [FIG. 5]

FIG. 5 shows control maps relating to pre-injection, ignition of pre-injected fuel, and main injection performed in the internal combustion engine shown in FIG. 1.

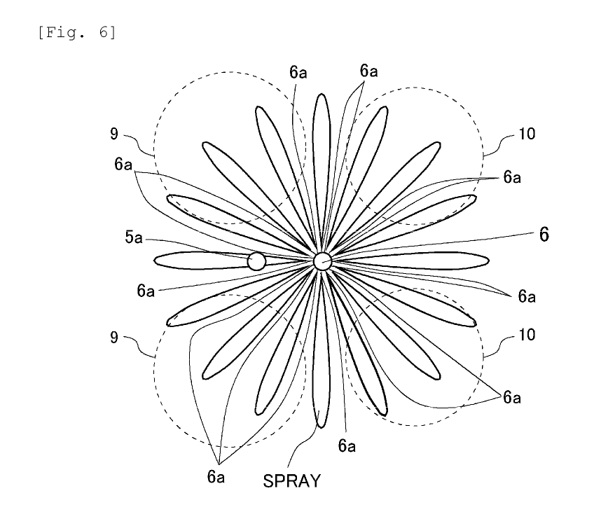

### [FIG. 6]

FIG. 6 shows how fuel is sprayed in a case where injection ports are arranged in such a way as to be capable of injecting fuel substantially radially in sixteen directions.

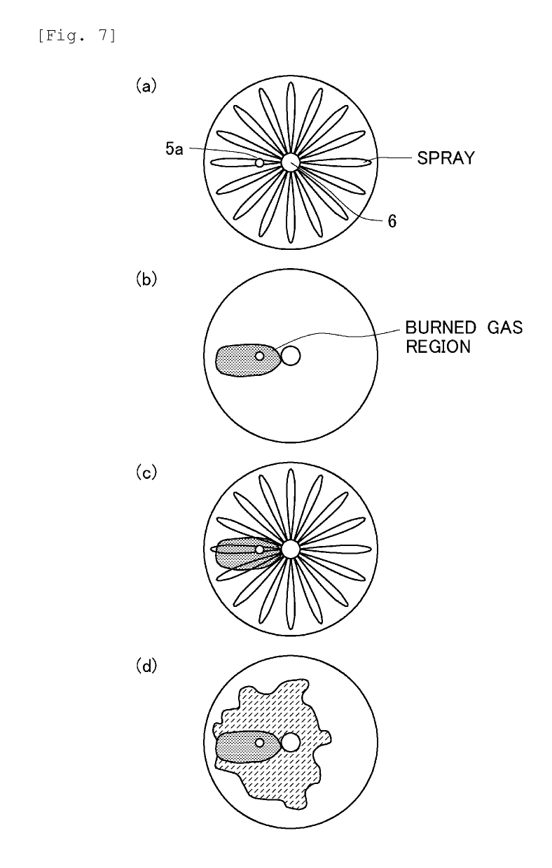

### [FIG. 7]

FIG. 7 includes diagrams schematically showing states in the combustion chamber at different stages during the period from the time after the pre-injection to the time after the main injection seen from above the combustion chamber in a case where the injection ports of the fuel injection valve are arranged at regular intervals about the center axis of the fuel injection valve.

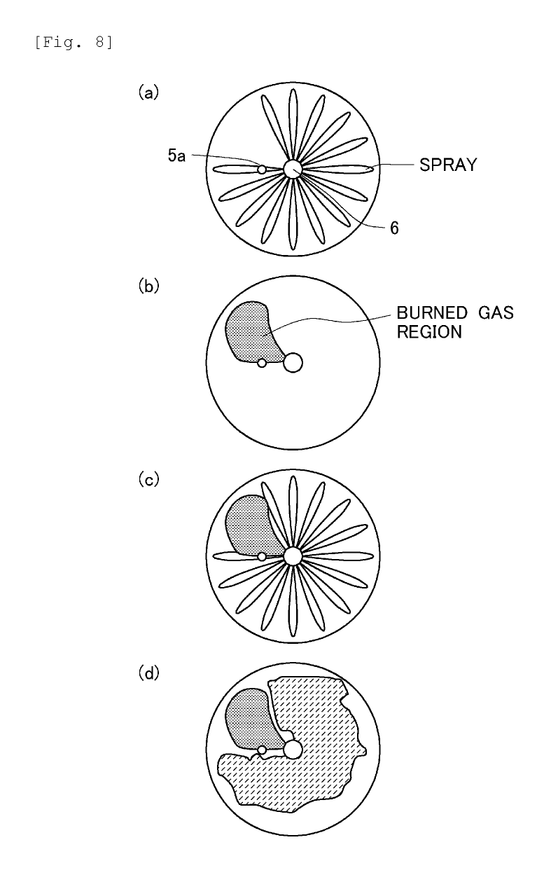

### [FIG. 8]

FIG. 8 includes diagrams schematically showing states in the combustion chamber at different stages during the period from the time after the pre-injection to the time after the main injection seen from above the combustion chamber in a case where the injection ports are arranged in such a way as not to be oriented to the burned gas region at the time of main injection.

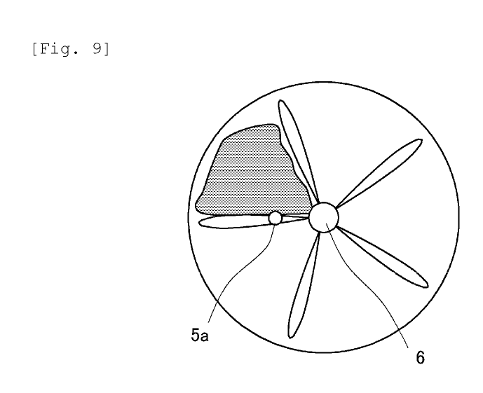

### [FIG. 9]

FIG. 9 is a diagram schematically showing a state at a time after the main injection in a case where the fuel injection valve has a relatively small number of injection ports that are arranged regularly.

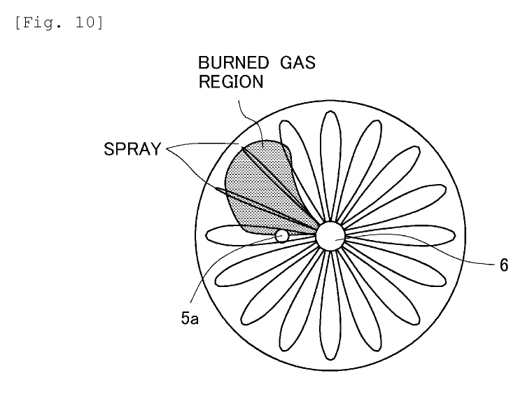

### [FIG. 10]

FIG. 10 is a diagram schematically illustrating the quantities of fuel injected from the respective injection ports of the fuel injection valve according to example 2.

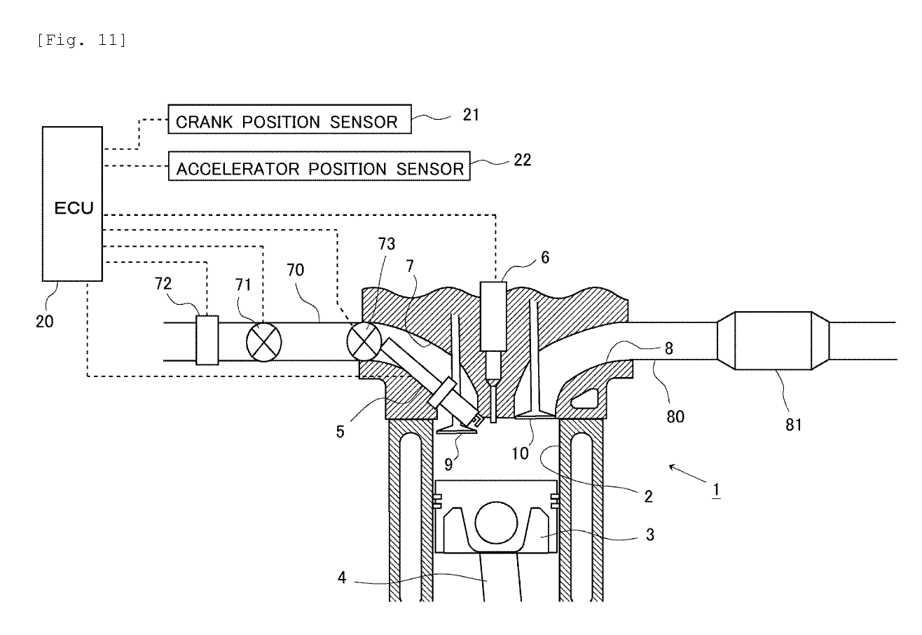

### [FIG. 11]

FIG. 11 is a diagram showing the general configuration of the air-intake and exhaust systems of an internal combustion engine according to example 3.

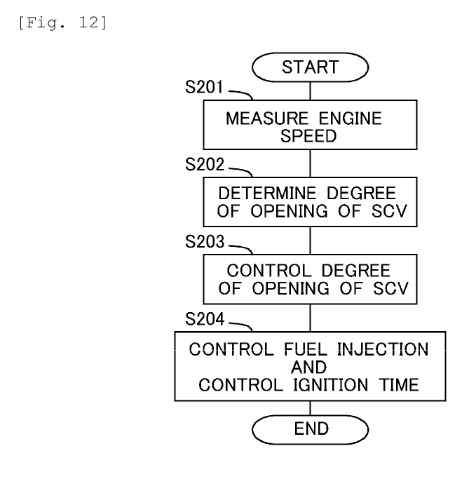

### [FIG. 12]

FIG. 12 is a flow chart of a process of controlling an SCV according to example 3.

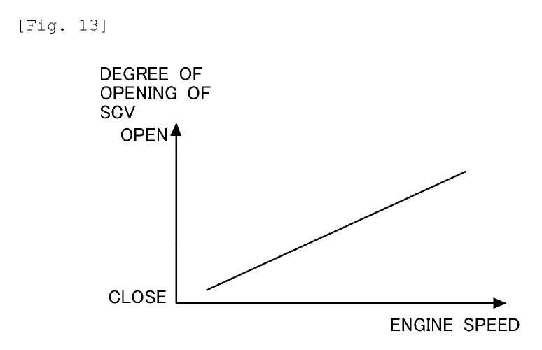

### [FIG. 13]

FIG. 13 is a graph showing the relationship between the engine speed and the degree of opening of the SCV.

### DESCRIPTION OF EMBODIMENTS

In the following, exemplary embodiments of the present invention will be described with reference to the drawings. The dimensions, materials, shapes, relative arrangements, and other features of the components that will be described in connection with the embodiments are not intended to limit the scope of the present invention only to them, unless particularly stated.

### EXAMPLE 1

FIG. 1 is a diagram showing the general configuration of an internal combustion engine according to example 1 and its air-intake and exhaust systems. The internal combustion engine 1 shown in FIG. 1 is a four-stroke-cycle internal combustion engine having a plurality of cylinders 2. FIG. 1 shows only one of the plurality of cylinders.

In each cylinder 2 of the internal combustion engine 1, a piston 3 is provided in a slidable manner. The piston 3 is linked with an output shaft (crankshaft), which is not shown in the drawings, by a connecting rod 4. The interior of the cylinder 2 is in communication with intake ports 7 and exhaust ports 8. An end of the intake port 7 opening into the cylinder 2 is opened/closed by an intake valve 9. An end of the exhaust port 8 opening into the cylinder 2 is opened/closed by an exhaust valve 10. The intake valve 9 and the exhaust valve 10 are driven to be opened/closed respectively by an intake cam and an exhaust cam not shown in the drawings.

Each cylinder 2 is provided with a fuel injection valve 6, which is arranged at the top center of the combustion chamber formed in the cylinder 2 to inject fuel into the cylinder. Each cylinder 2 is also provided with an ignition plug 5 on the cylinder head side of the internal combustion engine 1. The ignition plug 5 is capable of igniting fuel injected by the fuel injection valve 6. The fuel injection valve 6 will be further described later. In this example, the ignition plug 5 constitutes the ignition device according to the present invention.

The intake port 7 is in communication with an intake passage 70. A throttle 71 is provided in the intake passage 70. An air flow meter 72 is provided in the intake passage 70 upstream of the throttle 71. The exhaust port 8 is in communication with an exhaust passage 80. In the exhaust passage 80, there is provided an exhaust gas purification catalyst 81 for purifying the exhaust gas discharged from the internal combustion engine 1. As will be described later, the exhaust gas discharged from the internal combustion engine 1 has an air-fuel ratio leaner than the stoichiometry, and a selective catalytic reduction NOx catalyst capable of removing NOx contained in the exhaust gas having a lean air-fuel ratio may be employed as the exhaust gas purification catalyst 81.

Moreover, an ECU 20 is annexed to the internal combustion engine 1. The ECU 20 is an electronic control unit that controls the operation state of the internal combustion engine 1, the exhaust gas purification apparatus and other components. The ECU 20 is electrically connected with the above-described air flow meter 72, a crank position sensor 21, and the accelerator position sensor 22. Values measured by these sensors are supplied to the ECU 20. Thus, the ECU 20 can recognize the operation states of the internal combustion engine 1 such as the intake air quantity, the engine speed, and the engine load based on the measurement value of the air flow meter 72, the measurement value of the crank position sensor 21, and the measurement value of the accelerator position sensor 22 respectively. The ECU 20 is also electrically connected with the fuel injection valve 6, the ignition plug 5, and the throttle 71, which are controlled by the ECU 20. In this example, the ECU 20 serves as the controller in the present invention.

FIG. 2 is a diagram showing how fuel is sprayed from the fuel injection valve 6 in this example. The fuel injection valve 6 in this example has a portion in which no injection port 6a is provided so that fuel is not sprayed in a partial region (i.e. the region encircled by the chain line in FIG. 2) as shown in FIG. 2. FIG. 2 is a diagram showing the interior of the combustion chamber seen from the cylinder head side. FIG. 2 shows a case in which there is a clockwise swirl. As shown in FIG. 2, the injection ports 6a are arranged in such a way that fuel sprays do not enter the region encircled by the chain line. In the region encircled by the chain line, there is burned gas remaining after combustion of pre-injected fuel. This region will be hereinafter referred to as the “burned gas region”. This burned gas region will be specifically described later. As described above, the fuel injection valve 6 used in this example does not have an injection port 6a oriented in the direction from the center axis of the fuel injection valve 6 in which the burned gas region can exist at the time of main injection. The injection ports 6a are arranged near the end of the fuel injection valve 6 at regular intervals (or regular angular intervals) about the center axis of the fuel injection valve 6 (which may be the center axis of the cylinder 2) except for the injection ports 6a that are adjacent to the burned gas region. The center axis of the cylinder 2 in this example may be defined by the center axis of the fuel injection valve 6. It is not necessary that the center axis of the cylinder 2, the center axis of the fuel injection valve 6, and the center axis of the swirl coincide precisely. The injection ports 6a are arranged in such a way as to inject fuel in directions that form the same angle relative to the center axis of the cylinder 2. The centers of the opening ends of the injection ports 6a are located in the same plane perpendicular to the center axis of the cylinder 2. The position of the ignition plug 5 relative to the fuel injection valve 6, in particular the position of the region 5a between electrodes of the ignition plug 5, in which the ignition plug 5 is capable of igniting fuel, relative to the fuel injection valve 6, is set in such a way that at least one of the fuel sprays injected from the injection ports 6a passes through the region 5a and the fuel spray thus passing through the region 5a can be directly ignited by inter-electrode current flowing in the region 5a. The ignition plug 5 is located between the two intake valves 9 so that it does not interfere with the operations of the intake valves 9 and the exhaust valves 10.

The ignition plug 5 and the fuel injection valve 6 configured as above can bring about spray guide combustion. In other words, the fuel injection valve 6 and the ignition plug 5 arranged in such a way as to be capable of directly igniting fuel injected by the fuel injection valve 6 can ignite the injected fuel passing through the region 5a at any time irrespective of the opening timing of the intake valves 9 of the internal combustion engine 1 or the position of the piston 3. In contrast, in the case of air guide combustion in which fuel injected by the fuel injection valve is carried to the neighborhood of the ignition plug by means of air flowing into the combustion chamber with opening of the intake valve to ignite it and in the case of wall guide combustion in which injected fuel is carried to the neighborhood of the ignition plug utilizing the shape of a cavity provided on top of the piston to ignite it, it is difficult to perform fuel injection and ignition unless the time for opening the intake valve is reached and a predetermined piston position is established. The spray guide combustion performed in this example allows much more flexible fuel injection and ignition timing control as compared to the air guide combustion and the wall guide combustion. In this example, as shown in FIG. 2, the fuel injection valve 6 and the ignition plug 5 are arranged in such a way that one of fuel sprays injected from the injection ports 6a falls on the electrodes of the ignition plug 5. However, the ignition-capable region of the ignition plug 5 is not limited to the region 5a between the electrodes but includes a region around the electrodes also. Therefore, it is not necessarily required that a fuel spray injected from the injection port 6a falls on the electrodes of the ignition plug 5. In other words, it is not necessarily required that the ignition plug 5 be located in line with the direction of fuel injection from the injection port 6a (namely, on the center axis of the fuel spray). Even in the case where the fuel spray injected from the injection port 6a is offset from the electrodes of the ignition plug 5, spray guide combustion started by a spark generated between the electrodes of the ignition plug 5 can be brought about, so long as the fuel spray passes the ignition-capable region. Thus, in this example, what is required is that the position of the ignition plug 5 relative to the fuel injection valve 6 be arranged in such a way that spray guide combustion can be brought about. Therefore, the ignition plug 5 may be offset from the direction of fuel injection (namely, the center axis of the fuel spray) from the injection port 6a.

Combustion control performed with the internal combustion engine 1 configured as above will be described with reference to FIG. 3. FIG. 3(a) schematically shows procedure of fuel injection and ignition in combustion control performed in the internal combustion engine 1 in time sequence from left to right of the diagram (see upper row of FIG. 3(a)) and phenomena relating to combustion which are considered to occur in succession in the combustion chamber as results of the fuel injection and ignition (see the lower row of FIG. 3(a)). FIG. 3(b) shows relationship between pre-injection and main injection, which are shown in FIG. 3(a), and ignition in time line. The mode shown in FIG. 3 is given only as a schematic illustration of the combustion control performed according to the present invention, and the present invention should not be considered to be limited to this mode.

In the combustion control according to the present invention, pre-injection and main injection are performed in one cycle. The pre-injection is fuel injection performed through the fuel injection valve 6 at a predetermined time during the compression stroke. The main injection is fuel injection performed also through the fuel injection valve 6 at a time after the pre-injection and before the top dead center (TDC) of the compression stroke. As shown in FIG. 3(b), the injection start time of the pre-injection (which will be simply referred to as the “pre-injection time” hereinafter) is denoted by Tp, and the injection start time of the main injection (which will be simply referred to as the “main injection time” hereinafter) is denoted by Tm. The interval between the pre-injection and the main injection (Tm−Tp) is defined as the injection interval Di. Combustion with the pre-injection is performed as the above-described spray guide combustion, and the fuel injected by the pre-injection (which will be hereinafter referred to as “pre-injected fuel”) is ignited using the ignition plug 5. The time of this ignition is denoted by Ts as shown in FIG. 3(b), and the interval from the start of the pre-injection to the time of ignition (Ts−Tp) is defined as the ignition interval Ds.

In the following, the procedure of the combustion control according to the present invention will be described.

### (1) Pre-Injection

The pre-injection is firstly performed at a predetermined time during the compression stroke. The pre-injection time Tp is determined in relation to the later-described main injection. After the pre-injection is started, the fuel injected through the fuel injection valve 6 passes through the ignition-capable region 5a of the ignition plug 5 in the combustion chamber as shown in FIG. 2. Immediately after the start of the pre-injection, the pre-injected fuel is not diffused widely in the combustion chamber but travels in the combustion chamber by the penetrating force of injection while involving the air around at the leading end of the spay jet. Consequently, the pre-injected fuel creates air-fuel mixture stratified in the combustion chamber.

### (2) Ignition of Pre-injected Fuel

The pre-injected fuel thus stratified is ignited by the ignition plug 5 at time Ts after the ignition interval Ds from the start of the pre-injection. As described above, since the pre-injected fuel is stratified, the local air-fuel ratio is at a level allowing combustion by this ignition. Besides the effect of compression by the piston 3, the progress of combustion of the pre-injected fuel thus ignited causes a further temperature rise in the combustion chamber. On the other hand, in the present invention, a portion of the pre-injected fuel is not burned in the combustion caused by the ignition by the ignition plug 5 but remains in the combustion chamber as “unburned residual fuel”. Since the unburned residual fuel has been exposed to a high-temperature atmosphere resulting from the combustion of a portion of the pre-injected fuel in the combustion chamber, it is expected that at least a portion of the unburned residual fuel has been reformed to be improved in its combustibility by low temperature oxidation under a condition that does not cause it to be burned. It should be noted, however, that in the context of the present invention the unburned residual fuel refers to a portion of pre-injected fuel that remains without having been burned in the combustion caused by the ignition by the ignition plug 5, and it is not essential for the unburned residual fuel to be in a condition showing specific properties.

### (3) Main Injection

The main injection through the fuel injection valve 6 is performed at time Tm after the injection interval Di from the start of the pre-injection, in other words, at time Tm before the top dead center of the compression stroke after the lapse of time equal to Di−Ds from the time of ignition Ts by the ignition plug 5. In this internal combustion engine 1, the main-injected fuel is burned by diffusion combustion to contribute to the most part of the engine power as will be described later. The injection start time Tm of the main injection is set in such a way as to nearly maximize the engine power attained with a quantity of main fuel injection determined by the engine load and other factors. (The time thus set will be hereinafter referred to as “proper injection time”.) The fuel injected by the main injection started at time Tm is ignited by flame generated by the combustion of the pre-injected fuel, whereby the temperature in the combustion chamber is further raised. Moreover, the unburned residue of the pre-injected fuel and the main-injected fuel self-ignite with the rise in the temperature and are subjected to diffusion combustion. As described above, in cases where the combustibility of the unburned residual fuel has been enhanced, the combustion of the main-injected fuel is expected to progress more smoothly.

As described above, in the combustion control according to the present invention, the above-described series of combustions occur with intervening ignition by the ignition plug 5 in the period between the pre-injection and the main injection. In connection with the pre-combustion, the injection time Tp of the pre-injection or the injection interval Di is set in such a way as to enable the above-described series of combustion with the main injection performed at the proper injection time.

### <Combustion Control Flow>

FIG. 4 shows the flow of a specific process of the combustion control according to the present invention in the internal combustion engine 1. The combustion control shown in FIG. 4 is performed repeatedly by executing a control program stored in the ECU 20 while the internal combustion engine 1 is operating. FIG. 5 shows exemplary control maps used in the process of the combustion control. In the upper graph (a) in FIG. 5, line L30 represents relationship between the engine load of the internal combustion engine 1 and the pre-injection quantity, line L31 represents relationship between the engine load and the main injection quantity, and line L32 represents relationship between the engine load and the load-adapted injection quantity, which is the fuel injection quantity adapted to the engine load. Moreover, the upper graph (a) in FIG. 5 also shows the amount of the unburned residue M1 of the pre-injected fuel in relation to the engine load. In the lower graph (b) in FIG. 5, L33 represents relationship between the engine load of the internal combustion engine 1 and the pre-injection time Tp, L34 represents relationship between the engine load and the ignition time Ts, and L35 represents relationship between the engine load and the main injection time Tm. The horizontal axis of graph (b) in FIG. 5 represents the injection time, where larger values represent larger amounts of advancement from the top dead center of the compression stroke.

Firstly in step S101, the engine load of the internal combustion engine 1 is calculated based on the measurement value of the accelerator position sensor 22. Alternatively, the engine load of the internal combustion engine 1 may be calculated based on the air flow rate in the intake passage 70, namely the measurement value of the air flow meter 72 or the intake air pressure in the intake passage 70. Then, in step S102, a load-adapted injection quantity S0 is determined based on the engine load calculated in step S101. Specifically, a load-adapted injection quantity S0 adapted to the engine load is calculated using the control map represented by line L32 in graph (a) of FIG. 5. In this example, the relationship between the engine load and the load-adapted injection quantity S0 is recorded in the control map in which the load-adapted injection quantity S0 increases as the engine load increases. After the completion of the processing of step S102, the process proceeds to step S103.

In step S103, the main injection time Tm is determined using the control map represented by line L35 in graph (b) of FIG. 5. As described above, in order to improve the thermal efficiency of the internal combustion engine 1, the main injection time Tm is set to the proper injection time before the top dead center of the compression stroke. The proper injection time of the internal combustion engine 1 has been measured by experiment conducted previously for every value of the engine load, and the control map represented by line L35 has been prepared based on the result of measurement. In an exemplary case, the main injection time Tm is gradually advanced as the engine load increases, but it is kept at an upper limit advancement amount in a high load range R8 (i.e. the range in which the load-adapted injection quantity S0 is equal to or larger than S2, which will be described later). This is because the proper main injection time Tm is determined in accordance with the main injection quantity, which is kept at a constant value (maximum main injection quantity) in the high load range R8 as will be described later. After the completion of the processing of step S103, the process proceeds to step S104.

In step S104, it is determined whether or not the load-adapted injection quantity S0 determined in step S102 is equal to or smaller than a predetermined first injection quantity S1. The predetermined first injection quantity S1 is a threshold value corresponding to an engine load above which there arises a situation in which smoke is likely to be generated because of insufficiency of available air due to overlapping of the unburned reside of the pre-injected fuel and the main-injected fuel, if the pre-injection time Tp is advanced together with the main injection time Tm as described later (see the processing in step S106). Therefore, if the load-adapted injection quantity S0 is equal to or smaller than the predetermined first injection quantity S1, the internal combustion engine 1 is not in a situation in which smoke is likely to be generated. On the other hand, if the load-adapted injection quantity S0 exceeds the predetermined first injection quantity S1, the internal combustion engine 1 is in a situation in which smoke is likely to be generated. If the determination made in step S104 is affirmative, the process proceeds to step S105, and if negative, the process proceeds to step S110.

If the determination made in step S104 is affirmative, namely, if the load-adapted injection quantity S0 is equal to or smaller than the predetermined first injection quantity S1, the engine load of the internal combustion engine 1 is in a low load range R6 (see FIG. 5). Then, in step S105, the pre-injection quantity Sp is set to a minimum pre-injection quantity Spmin. Consequently, when the engine load is in the low load range R6, the pre-injection quantity Sp is fixed at the minimum pre-injection quantity Spmin as shown by line L30 in graph (a) of FIG. 5. After the completion of the processing of step S105, the process proceeds to step S106.

In step S106, the pre-injection time Tp is determined using the control map represented by line L33 in graph (b) of FIG. 5. In the low load range R6, the pre-injection time Tp may be set in such a way as to provide an injection interval Di that leads to an appropriate thermal efficiency. Therefore, in the low load range R6, in which the pre-injection quantity Sp is fixed at the minimum pre-injection quantity Spmin, the pre-injection time Tp is set in such a way that the injection interval Di is kept constant throughout the low load range R6, namely in such a way that the pre-injection time Tp is changed together with the main injection time Tm determined in step S103 in the same manner. In step S107, the ignition time Ts is determined using the control map represented by line L34 in graph (b) of FIG. 5. Specifically, as with the pre-injection interval Tp, the ignition time Ts is set in such a way that the ignition interval Ds is kept constant throughout the low load range R6, because the pre-injection quantity Sp is fixed at the minimum pre-injection quantity in the low load range R6.

In step S108, the main injection quantity Sm is calculated using the control map represented by line L31 in graph (a) of FIG. 5. In the low load range R6, the correlation between the engine load and the main injection quantity represented by line L31 follows the following equation 1

Sm=S0−Sp×α (equation 1),

where α is the unburned residue rate of the pre-injection fuel.

As described above, in the combustion control according to the present invention, the unburned residue of the pre-injected fuel self-ignites and is burned by diffusion combustion together with the main-injected fuel to contribute to the engine power, whereby the thermal efficiency of the internal combustion engine 1 can be improved. In terms of the contribution to the engine power, a portion of the pre-injection fuel or the unburned residue thereof can be regarded to be equivalent to the main-injected fuel. Therefore, it is possible to calculate the main injection quantity Sm taking into account characteristics of the combustion control according to the present invention by measuring the coefficient α representing the unburned residue rate of the pre-injected fuel in advance by an experiment or other process and using the aforementioned equation 1. As described above, the unburned residue rate of the pre-injected fuel changes depending on the pre-injection time, the ignition interval Ds, and the injection interval Di. Therefore, the value of the coefficient α is determined based on them. In cases where the quantity of fuel burned by ignition with the ignition plug 5 (i.e. the quantity of fuel burned by spray guide combustion) is very small relative to the total pre-injection quantity, the coefficient α may be set to be equal to 1 in the control. In this case, it is assumed in the control that the load-adapted injection quantity is equal to the total injection quantity. After the completion of the processing in step S108, the process proceeds to step S130.

As the parameters relating to pre-injection, main injection, and ignition are determined in the above-described manner, in the low load range R6, the unburned residue of the pre-injected fuel represented by M1 in graph (a) of FIG. 5 remains after the ignition of the pre-injected fuel. As described above, in the low load range R6, since the pre-injection quantity Sp is fixed at the minimum pre-injection quantity Spmin and the ignition interval Ds and the injection interval Di are also fixed, the amount of unburned residue of the pre-injected fuel is substantially constant.

If the determination made in step S104 is negative, the process proceeds to step S110. In step S110, it is determined whether or not the load-adapted injection quantity S0 determined in step S102 is equal to or smaller than a predetermined second injection quantity S2. The predetermined second injection quantity S2 is a threshold value corresponding to an engine load above which the quantity of fuel injected at the proper injection time in the gasoline engine is relatively so large that there arises a situation in which self-ignition diffusion combustion is likely to be affected by its evaporation latent heat to become unstable and smoke is likely to be generated because of insufficiency of air (oxygen) around its fuel spray. In other words, the predetermined second injection quantity S2 is the largest limit injection quantity that can be injected at the proper injection time in the gasoline engine in view of the stability of combustion and smoke. Therefore, if the load-adapted injection quantity S0 is equal to or smaller than the second injection quantity S2, there is a situation in which smoke is unlikely to be generated. On the other hand, if the load-adapted injection quantity S0 exceeds the predetermined second injection quantity S2, there is a situation in which smoke can be generated. If the determination made in step S110 is affirmative, the process proceeds to step S111, and if negative, the process proceeds to step S121.

If the determination made in step S110 is affirmative, namely if the load-adapted injection quantity S0 is larger than the predetermined first injection quantity S1 and equal to or smaller than the predetermined second injection quantity S2, the engine load of the internal combustion 1 is in a middle load range R7 (see FIG. 5). In this case, the process proceeds to steps S111 and S112. In step S111, the pre-injection quantity Sp is determined using the control map represented by line L30 in graph (a) of FIG. 5, and in step S112, the pre-injection time Tp is determined using the control map represented by line L33 in graph (b) of FIG. 5. Specifically, in the middle load range R7, the load-adapted injection quantity S0 is larger than the predetermined first injection quantity S1, and therefore it is necessary to reduce the generation of smoke resulting from interference of the unburned residue of the pre-injected fuel and the main-injected fuel. Therefore, as described before, the pre-injection time Tp is advanced further, in addition to the advancement made together with the advancement of the main injection time Tm by the same amount, in response to increases in the engine load (i.e. increases in the load-adapted injection quantity S0) in order to reduce the generation of smoke. The pre-injection time Tp may be set appropriately taking into consideration the balance between the thermal efficiency and the amount of generated smoke. Thus, it is possible to reduce the generation of smoke without sacrificing the thermal efficiency of the internal combustion engine 1 by increasing the pre-injection quantity Sp in accordance with an increase in the amount of advancement of the pre-injection time Tp as represented by line L30, thereby increasing the unburned residue of the pre-injected fuel and burning it with the main-injected fuel.

Then in step S113, the ignition time Ts is determined using the control map represented by line L34 in graph (b) of FIG. 5. Specifically, the amount of advancement of the ignition time Ts is increased by an amount same as the increase in the amount of advancement of the pre-ignition time Tp determined in step S112 in response to the increase in the engine load. In other words, in the middle load range R7, the ignition time Ts is advanced in response to the increase in the engine load with the ignition interval Ds being kept constant. After the completion of the processing in step S113, the process proceeds to step S114.

In step S114, the main injection quantity Sm is determined using the control map represented by line L31 in graph (a) of FIG. 5. In the middle load range R7 also, as with in the low load range R6, the relationship between the engine load and the main injection quantity Sm represented by line L31 follows the above-mentioned equation 1. Therefore, the main injection quantity Sm can be determined taking into account characteristics of the combustion control according to the present invention, as with in the processing of step S108. In the middle load range R7, since the pre-injection quantity Sp is increased with an increase in the engine load, the increase rate of the main injection quantity Sm (i.e. the rate of increase in the main injection quantity Sm relative to the increase in the engine load) in the middle load range R7 is smaller than the increase rate of the main injection quantity Sm in the low load range R6. After the completion of the processing of step S114, the process proceeds to step S130.

With the parameters relating to the pre-injection, main injection, and ignition determined as described above, the unburned residue of the pre-injected fuel represented by M1 in graph (a) of FIG. 5 remains after the ignition of the pre-injected fuel in the middle load range R7. As described above, in the middle load rage R7, the pre-injection quantity is increased in response to the increase in the engine load, and the pre-injection time Tp and the ignition time Ts are advanced with the ignition interval Ds being fixed. Consequently, the amount of unburned residue also increases with the increase in the engine load.

If the determination made in step S110 is negative, namely if the load-adapted injection quantity S0 is larger than the predetermined second injection quantity S2, the engine load of the internal combustion engine 1 is in the high load range R8 (see FIG. 5). In this case, the process proceeds to step 121. In step S121, the main injection quantity Sm is determined using the control map represented by line L31 in graph (a) of FIG. 5. Specifically, in the high load range R8, the main injection quantity Sm is made relatively large in response to the increase in the engine load. As described above, if the main injection quantity becomes somewhat large, combustion would become unstable due to the effect of evaporation latent heat during the injection, and smoke is likely to be generated due to insufficiency of air (oxygen) around injected fuel spray. In view of this, in the high load range R8, the main injection quantity Sm is set to a maximum main injection quantity Smmax, which is the upper limit of the main injection quantity with which stable combustion is ensured and the generation of excessively large amount of smoke can be prevented. After the completion of the processing of step S121, the process proceeds to step S122.

In step S122, the pre-injection quantity Sp is calculated using the control map represented by line L30 in graph (a) of FIG. 5. In the high load range R8, the relationship between the engine load and the pre-injection quantity Sp represented by line L30 is expressed by the following equation 2:

Sp=(S0−Sm)/α (equation 2).

In the above equation 2, α is the unburned residue rate of the pre-injection fuel, as with in equation 1. In the high load range R8, the main injection quantity Sm is fixed at the maximum main injection quantity Smmax for the above-described reason. Thus, by using the above equation 2, the pre-injection quantity Sp can be determined taking into account characteristics of the combustion control according to the present invention for essentially the same reason as in the processing of steps S108 and S114. After the completion of the processing in step S122, the process proceeds to step S123.

In step S123, the pre-injection time Tp is determined using the control map represented by line L33 in graph (b) of FIG. 5. Specifically, in the high load range R8, since the total injection quantity S0 is larger than the predetermined second injection quantity S2, the main injection quantity Sm is fixed at the maximum main injection quantity Smmax determined in step S121 in order to ensure stable combustion and to reduce smoke. Therefore, in order to achieve required engine load, the pre-injection quantity Sp is determined to be a value larger than the values in the middle load range R7 according to the aforementioned equation 2. As the pre-injection quantity Sp becomes thus large, there arises again the possibility of the generation of smoke due to interference of the unburned residue of the pre-injected fuel and the main-injected fuel. Therefore, as seen from line L33 in graph (b) of FIG. 5, the pre-injection time Tp is advanced more greatly than in the case where the engine load is in the middle load range R7, in other words, the pre-injection time Tp is set in such a way that the injection interval Di in the high load range R8 is increased with increases in the engine load, to thereby reduce smoke. In determining the amount of advancement of the pre-injection time Tp, since there is the possibility of smoke generation in the high load range R8 as described above, it is preferred that the pre-injection time Tp be set appropriately giving a higher priority to reduction of smoke by the advancement of the pre-injection time. If the reduction of smoke can be achieved as desired, the pre-injection time Tp may be set appropriately taking into consideration the relationship between the injection interval Di and the thermal efficiency of the internal combustion engine 1. After the completion of the processing of step S123, the process proceeds to step S124.

Then, in step S124, the ignition time Ts is determined using the control map represented by line L34 in graph (b) of FIG. 5. Specifically, the ignition time Ts is advanced with increases in the engine load, where the increase rate of the amount of advancement (i.e. rate of the increase in the amount of advancement to the increase in the engine load) is smaller than the increase rate of the amount of advancement of the pre-injection. Consequently, in the high load range R8, while both the pre-injection time Tp and the ignition time Ts are increased with increases in the engine load, the ignition interval Ds increases with increases in the engine load. Consequently, in the high load range R8, the amount of unburned residue of the pre-injected fuel, which is subjected to combustion together with the main-injected fuel, can be greatly increased (see M1 in graph (a) of FIG. 5). As described above, although the main injection quantity is fixed at the maximum main injection quantity in the high load range R8, it is possible to respond to the required engine load and to keep the thermal efficiency of the internal combustion engine 1 at satisfactory levels by increasing the amount of unburned residue of the pre-injected fuel in the above-described way. After the completion of the processing of step S124, the process proceeds to step S130.

With the parameters relating to the pre-injection, main injection, and ignition determined as described above, the unburned residue of the pre-injected fuel represented by M1 in graph (a) of FIG. 5 remains after the ignition of the pre-injected fuel in the high load range R8. As described above, in the high load rage R8, the pre-injection quantity Sp is increased in response to the increase in the engine load, and the pre-injection time Tp and the ignition time Ts are advanced with the ignition interval Ds being increased. Since the main injection quantity Sm is fixed at the maximum main injection quantity Smmax, the rate of increase in the pre-injection quantity Sp to the increase in the engine load is higher than in the case where the engine load is in the middle load range R7. Consequently, the amount of unburned residue increases with increases in the engine load more greatly than in the case where the engine load is in the middle load range R7.

After the completion of the processing of any one of the steps S108, S114, and S124, the processing of S130 is executed. In step S130, the pre-injection and the main injection by the fuel injection valve 6 and the ignition by the ignition plug 5 are performed according to the pre-injection quantity Sp, the pre-injection time Tp, the main injection quantity Sm, the main injection time Tm, and the ignition time Ts that have been determined in the foregoing processing. After the completion of the processing of step S130, the process starting from step S101 is performed again.

According to this combustion control, it is possible to achieve both stable diesel combustion with reduced smoke generation and improvement in the thermal efficiency of the combustion by appropriately determining the pre-injection quantity Sp, the pre-injection time Tp, the main injection quantity Sm, the main injection time Tm, and the ignition time Ts responsive to the engine load. Moreover, preferable combustion is realized over a wide operation range of the internal combustion engine ranging from the low load range to the high load range.

### <Fuel Injection Valve>

All the injection ports 6a of the fuel injection valve 6 may be arranged at regular intervals. FIG. 6 shows fuel sprays in a case in which the injection ports 6a are arranged in such a way as to be capable of injecting fuel substantially radially in sixteen directions. In this case, the injection ports 6a are provided near the end of the fuel injection valve 6 and arranged at regular intervals (or regular angular intervals) about the center axis of the fuel injection valve 6 (which may be the center axis of the cylinder 2). In the internal combustion engine 1 configured as above, the phenomena described in the following can occur.

FIG. 7 includes diagrams schematically showing states in the combustion chamber at different stages during the period from the time after the pre-injection to the time after the main injection seen from above the combustion chamber in the case where the fuel injection valve 6 has the sixteen injection ports 6a that are arranged at regular intervals about the center axis of the fuel injection valve 6. In the case shown in FIG. 7, there is no swirl in the combustion chamber.

Diagram (a) in FIG. 7 shows the state at a time after the pre-injection and before the ignition by the ignition plug 5. At this time, fuel sprays are extending regularly. Diagram (b) in FIG. 7 shows the state at a time after ignition by the ignition plug 5 and immediately before the main injection. Fuel existing in the ignition-capable region 5a at the time of ignition by the ignition plug 5 has been burned, and burned gas remains in a region around the ignition-capable region 5a. This region in which burned gas remains after the combustion of the pre-injected fuel is what is referred to as the burned gas region. Fuel sprays to which flame does not propagate because of the distance from the ignition-capable region 5a are not burned and remain in the combustion chamber as unburned residual fuel. In the case where there is no swirl, the burned gas region stays in the neighborhood of the ignition-capable region 5a, though it extends due to the combustion of the pre-injected fuel.

Diagram (c) in FIG. 7 shows the state at a time immediately after the main injection. In this state, a portion of the main-injected fuel is in the burned gas region. Diagram (d) in FIG. 7 shows the state at a time during the combustion of the main-injected fuel. Diffusion combustion of the main-injected fuel starts from a location at which the main-injected fuel touches the outer boundary of the burned gas region. However, the main-injected fuel in the burned gas region burns only slowly because of insufficiency of oxygen, and there is a possibility that smoke may be generated. FIG. 7 shows a case in which no swirl is generated. In cases where a swirl is generated also, the main injection directed to the burned gas region can lead to the generation of smoke due to insufficiency of oxygen.

As shown in FIG. 2, the fuel injection valve 6 used in this example does not have injection ports 6a oriented to directions from the center axis of the fuel injection valve 6 in which the burned gas region can exist at the time of main injection. Thus, the fuel injection valve 6 has a plurality of injection ports 6a that are provided in such a way that the quantity of main-injected fuel injected to a burned gas region that is defined by a predetermined angular range as large as or smaller than 90 degrees about the fuel injection valve 6 from the location of the ignition plug 5 (which may be the location of the ignition-capable region 5a) in the direction of rotation of a swirl is smaller than the quantity of main-injected fuel injected to a region that is located adjacent to or apart from the burned gas region in the direction of rotation of the swirl, does not include the burned gas region, and is defined by an angle equal to the angle of the aforementioned predetermined angular range to have the same size as the burned gas region. In this example, the burned gas region corresponds to the predetermined region according to the present invention. The predetermined region is a region in the combustion chamber in which burned gas of the pre-injected fuel is expected to exist at the time when the main injection is performed after the burned gas of the pre-injected fuel has been carried by the swirl. In this example, the internal combustion engine 1 is configured in such a way that a swirl is generated in the combustion chamber. For example, the intake port 7 may be adapted in such a way as to generate a swirl. Alternatively, the internal combustion engine 1 may be provided with a swirl control valve adapted to generate a swirl by varying the channel cross sectional area of the intake port 7.

FIG. 8 includes diagrams schematically showing states in the combustion chamber at different stages during the period from the time after the pre-injection to the time after the main injection seen from above the combustion chamber in the case where the injection ports 6a of the fuel injection valve 6 are arranged in such a way as not to be oriented to the burned gas region at the time of main injection. FIG. 8 shows the interior of the combustion chamber seen from the cylinder head side in a case where there is a clockwise swirl.

Diagram (a) in FIG. 8 shows the state at a time after the pre-injection and before the ignition by the ignition plug 5. At this time, pre-injected fuel exists in the ignition-capable region 5a. In contrast, a spray of the pre-injection does not exist in the region immediately downstream of the ignition-capable region 5a with respect to the direction of rotation of the swirl.

Diagram (b) in FIG. 8 shows the state at a time after the ignition by the ignition plug 5 and immediately before the main injection. Fuel existing in the ignition capable region 5a at the time of ignition by the ignition plug has been burned, and there is a burned gas region. Flame does not propagate to fuel sprays distant from the ignition capable region 5a, and unburned residual fuel remains in the combustion chamber.

Diagram (c) in FIG. 8 shows the state at a time immediately after the main injection. At this time, the burned gas region has been shifted by the swirling flow in the direction of rotation of the swirl. In this state, a portion of the main injection fuel touches the outer boundary of the burned gas region. In other words, the burned gas region is extending between the fuel spray injected from an injection port 6a and passing through the ignition-capable region 5a and the fuel spray injected from the injection port 6a immediately downstream of the injection port 6a from which the fuel spray passing through the ignition-capable region 5a is injected with respect to the direction of rotation of the swirl. In the burned gas region, oxygen has been consumed in combustion of the pre-injected fuel. Consequently, the oxygen concentration in the burned gas region is lower than the oxygen concentration in the other regions. Therefore, if the main-injected fuel exists in the burned gas region, there is a possibility that oxygen needed to burn the main-injected fuel can be insufficient in the burned gas region. Consequently, smoke may be generated in the burned gas region. In the fuel injection valve 6 of this example, the injection ports 6a are arranged in such a way that fuel is not injected to the burned gas region in the main injection.

Diagram (d) in FIG. 8 shows the state at a time after the start of combustion of the main-injected fuel. When the main-injected fuel passes the neighborhood of the outer boundary of the burned gas region, combustion is started by flame generated by combustion of the pre-injected fuel, and the main-injected fuel is burned by self-ignition diffusion combustion together with the unburned residue of the pre-injected fuel. Since the diffusion combustion starts immediately after the main-injection, the sprays of the main injected fuel and the burned portion of the main-injected fuel are not likely to be affected by the swirl. Moreover, the rotation speed of the swirl has been slowed down by the combustion of the pre-injected fuel. Therefore, the sprays of the main-injected fuel and the burned portion of the main-injected fuel are not likely to shift in the direction of rotation of the swirl. We have experimentally verified this fact. Therefore, the main-injected fuel is unlikely to enter the burned gas region. Consequently, there is little main-injected fuel in the burned gas region, and insufficiency of oxygen in combustion of the main-injected fuel can be prevented. Therefore, the generation of smoke can be reduced. For the above reasons, in this example the injection ports 6a are arranged in such a way as to make the quantity of the main-injected fuel entering the burned gas region small and to cause the main-injected fuel to pass the neighborhood of the outer boundary of the burned gas region.

As described above, the interval between two injection ports 6a is set in such a way that the burned gas region extends between two adjacent fuel sprays when the main injection is performed. With this setting, the main-injected fuel can be prevented from entering the burned gas region. Consequently, insufficiency of oxygen in combustion of the main-injected fuel can be prevented, and the generation of smoke can be reduced.

Even if the main-injected fuel enters the burned gas region, generation of smoke can be prevented or made small as long as the quantity of main-injected fuel entering the unburned gas region is small. Specifically, even in the case where there are injection ports 6a oriented to the burned gas region, even though the main-injected fuel enters the burned gas region, amount of smoke can be reduced as long as the intervals between the adjacent injection ports 6a are larger than the intervals of the injection ports 6a that are not oriented to the burned gas region. Therefore, the advantageous effect of the present invention can be enjoyed if the intervals between the injection ports 6a oriented to the burned gas region are larger than the intervals of the injection ports 6a that are not oriented to the burned gas region. In other words, the advantageous effects of the present invention can be enjoyed if the intervals between the injection ports 6a in the aforementioned predetermined angular range are larger than the intervals between the injection ports 6a outside the aforementioned predetermined angular range.

The location of the burned gas region at the time of the main injection may vary depending on the operation state of the internal combustion engine 1. Therefore, the intervals between the injection ports 6a may be set in such a way that the main-injected fuel will not enter the burned gas region when the internal combustion engine 1 is in a predetermined operation range. The predetermined operation range is, for example, a range in which the amount of smoke generated can be large. Alternatively, the intervals of the injection ports 6a may be set in such a way that the main-injected fuel will not enter the burned gas region in all the assumed operation states of the internal combustion engine 1.

As described above, in this example, while the intervals between the injection ports 6a that are oriented in directions from the center axis of the fuel injection valve 6 toward the burned gas region at the time of main injection are relatively larger than the intervals between the injection ports 6a that are not oriented in directions from the center axis of the fuel injection valve 6 toward the burned gas region so that the main-injected fuel is kept away from the burned gas region, the intervals between the injection ports 6a that are not oriented in directions from the center axis of the fuel injection valve 6 toward the burned gas region are relatively small. If the fuel injection valve has a relatively small number of injection ports that are arranged at regular intervals, there may also be a case in which no injection port is oriented to the burned gas region at the time of main injection. In other words, the large intervals that are set in order that the injection ports are not oriented to the burned gas region may also be applied to the portions that do not face the burned gas region. In such a case, it is at least possible to prevent the main-injected fuel from passing through the burned gas region. However, this arrangement is not desirable for the reason described in the following.

FIG. 9 is a diagram schematically shows the state at a time after the main injection in a case where the fuel injection valve has a relatively small number of injection ports that are arranged regularly. The relatively large regular intervals of the injection ports as shown can prevent the main-injected fuel from entering the burned gas region. However, as all the injection ports are arranged at regular intervals, flame is not apt to propagate in regions remote from the burned gas region, e.g. in the region opposite to the burned gas region with respect to the fuel injection valve, due to large intervals between adjacent fuel sprays. Consequently, diffusion combustion is not apt to occur. Therefore, there is a possibility of smoke generation. Moreover, relatively large intervals between the injection ports lead to a large quantity of fuel injected through one injection port in the main injection. Consequently, the air-fuel ratio will become excessively rich locally, possibly leading to generation of smoke.

In the case of the fuel injection valve 6 in this example, since the intervals between the injection ports 6a that are not oriented to the burned gas region at the time of main injection are relatively small, flame starting from the outer boundary of the burned gas region is likely to propagate to the adjacent fuel spray. Therefore, diffusion combustion is likely to occur. Moreover, since small intervals between the injection ports 6a lead to a large number of injection ports 6a, the quantity of fuel injected through one injection port in the main injection is relatively small. Therefore, it is possible to prevent the concentration of fuel from becoming excessively high locally. Consequently, the generation of smoke can be reduced.

As described above, in this example, spray guide combustion is brought about by igniting the pre-injected fuel using the ignition plug 5, and thereafter the main injection is performed to bring about diffusion combustion and self-ignition combustion. Thus, it is possible to bring about combustion similar to diesel combustion. Therefore, it is possible to achieve a very high thermal efficiency. Moreover, the injection ports 6a of the fuel injection valve 6 are arranged in such a way that the main-injected fuel is unlikely to enter the region in which the oxygen concentration has been lowered due to combustion of the pre-injected fuel. Therefore, deterioration of the combustion condition of the main-injected fuel can be prevented. In consequence, it is possible to reduce the generation of smoke and to further improve the thermal efficiency.

### EXAMPLE 2

In example 1, the intervals of the injection ports 6a are set in such a way that no injection ports 6a are oriented to the burned gas region at the time of main injection or that the quantity of main-injected fuel entering the burned gas region is relatively small. On the other hand, in example 2, the injection ports 6a of the fuel injection valve 6 are arranged at regular intervals. In other words, the fuel injection valve 6 has injection ports 6a oriented to the burned gas region at the time of main injection. Moreover, the size of the injection ports 6a oriented to the burned gas region at the time of main injection is smaller than the size of the injection ports 6a that are not oriented to the burned gas region. The size of the injection port 6a may refer to either the diameter of the injection port 6a or the cross-sectional areas which are provided in a direction perpendicularly intersecting an axial direction of the injection port 6a.

The small size of the injection port 6a makes the quantity of fuel injected through it relatively small. Consequently, in this example, although main-injected fuel enters the burned gas region, the shapes of the injection ports 6a are designed in such a way as to make the quantity of main-injected fuel entering the burned gas region relatively small. Therefore, it can be said that the fuel injection valve 6 has a plurality of injection ports 6a that are provided in such a way that the quantity of main-injected fuel injected to a predetermined region (i.e. burned gas region) that is defined by a predetermined angle equal to or smaller than 90 degrees about the fuel injection valve 6 from the location of the ignition plug 5 (which may be the location of the ignition-capable region 5a) in the direction of rotation of a swirl is smaller than the quantity of main-injected fuel injected to a region that is located adjacent to or apart from the burned gas region in the direction of rotation of the swirl, does not include the predetermined region, and is defined by an angle equal to the predetermined angle to have the same size as the predetermined region.

FIG. 10 is a diagram schematically illustrating the quantity of fuel injected by each injection port 6a of the fuel injection valve 6 in this example. FIG. 10 schematically shows the state in the combustion chamber seen from the cylinder head side. The quantity of fuel injected by each injection port 6a is represented by the width of the illustrated fuel spray. Larger spray widths represent larger fuel injection quantities. Therefore, it should be understood that the width of sprays illustrated may be different from the actual width of sprays. In FIG. 10, the injection ports 6a that are small in size are the injection ports 6a that face the burned gas region at the time of main injection, or the injection ports 6a that are provided at locations at which injection ports 6a are not provided in example 1.

In the burned gas region, the quantity of oxygen available for combustion of the main-injected fuel can be insufficient because the oxygen concentration is low in the burned gas region. The fuel injection valve 6 of this example makes the quantity of main-injected fuel entering the burned gas region small, so that it can prevent insufficiency of oxygen from occurring. Even if the quantity of oxygen becomes insufficient, the amount of smoke generated can be reduced. The optimum size of each injection port 6a can be determined by experiment or simulation.

As described above, in this example, it is possible to make the quantity of main-injected fuel entering the burned gas region relatively small, thereby preventing deterioration of the combustion condition. Consequently, the generation of smoke can be reduced.

In this example, what is essential is that the size of at least one or some of the injection ports 6a oriented to the burned gas region be smaller than the size of the other injection ports 6a. Therefore, the injection ports 6a oriented to the burned gas region 6a may include an injection port(s) having the same size as the injection ports 6a that are not oriented to the burned gas region. In this example, the injection ports 6a of the fuel injection valve 6 are arranged at regular intervals. Alternatively, the intervals between the injection ports 6a oriented to the burned gas region may be larger than the intervals between the injection ports 6a oriented to the other region, as is the case in example 1.

### EXAMPLE 3

FIG. 11 is a diagram showing the general configuration of an internal combustion engine and its air-intake and exhaust systems according to example 3. In the following, features of the internal combustion engine according to example 3 that are different from the internal combustion engine shown in FIG. 1 will be mainly described.

In this example, each cylinder is provided with two intake ports 7, one of which is provided with a swirl control valve (which will be hereinafter referred to as SCV) 73, which can be opened and closed. In this example, the SCV 73 corresponds to the swirl control valve according to the present invention. The operation of the SCV 73 is controlled by the ECU 20. When the degree of opening of the SCV 73 is made small, the quantity of air flowing into the cylinder through one intake port 7 becomes smaller than the quantity of air flowing into the cylinder through the other intake port 7. Thus, the quantity of air flowing in the direction of rotation of the swirl in the combustion chamber is increased. Consequently, the speed of the swirl is increased. In other words, the speed of the swirl can be controlled by controlling the degree of opening of the SCV 73. The structure of the SCV 73 is not limited to that described above. Other structures that can vary the quantity of air flowing through one intake port 7 and the quantity of air flowing in the other intake port 7 relative to each other may also be employed. In the case where each cylinder is provided with only one intake port 7 also, the SCV 73 can be provided. In this case, closing the SCV 73 makes the air flow in the intake port 7 uneven, and the air flowing into the cylinder in such an uneven state increases the speed of the swirl.

The speed of the swirl can change depending on the operation state of the internal combustion engine 1, in particular, depending on the engine speed of the internal combustion engine 1. Specifically, the higher the engine speed of the internal combustion engine 1 is, the higher the speed of the intake air flowing through the intake port 7 is, and the higher the speed of the swirl can be. Since the burned gas region shifts with the swirling flow, the distance over which the burned gas region shifts until the start of the main injection increases as the speed of the swirl increases. Therefore, the location of the burned gas region at the time of the main injection can change depending on the engine speed of the internal combustion engine 1. However, the position and the size of the injection ports of the fuel injection valve 6 cannot be changed in the state in which the fuel injection valve 6 is mounted in the internal combustion engine 1. Moreover, the interval between the pre-injection and the main injection is set to an optical interval, which is not allowed to be changed greatly. Therefore, in the case where the above-described fuel injection valve 6 of this example is employed, there is a possibility that the burned gas region may shift to a location at which a large amount of main-injected fuel is present, when the internal combustion engine 1 is operating at certain engine speeds. If the injection ports are arranged in such a way that the quantity of pre-injected fuel is small in a range in which the burned gas region that shifts depending on the engine speed of the internal combustion engine 1 can be located, it may be difficult for the main-injected fuel to reach the outer boundary of the burned gas region, when the internal combustion engine 1 is operating at certain engine speeds.

In view of the above, in this example, the degree of opening of the SCV 73 is controlled in such a way that the speed of the swirl does not change. Specifically, the higher the engine speed of the internal combustion engine 1 is, the larger the degree of opening of the SCV 73 is made. The relationship between the engine speed of the internal combustion engine 1 and the degree of opening of the SCV 73 can be determined in advance by experiment or simulation. The degree of opening of the SCV 73 may be changed either continuously or stepwise depending on the engine speed of the internal combustion engine 1. The degree of opening of the SCV 73 may be controlled in such a way that the speed of the swirl does not change at all. Alternatively, the speed of the swirl may be allowed to change, so long as the amount of smoke generated is kept within an allowable range.

FIG. 12 is a flow chart of a process of controlling the SCV 73 according to this example. This process is executed by the ECU 20 at predetermined time intervals.

In step S201, the engine speed is measured. In this example, the engine speed is firstly measured for the purpose of controlling the degree of opening of the SCV 73 based on the engine speed. The ECU 20 obtains the engine speed using the crank position sensor 21. After the completion of the processing of step S201, the process proceeds to step S202.

In step S202, the degree of opening of the SCV 73 is determined. FIG. 13 is a graph showing the relationship between the engine speed and the degree of opening of the SCV 73. The higher the engine speed is, the larger the degree of opening of the SCV 73 is made. The relationship shown in FIG. 13 is determined in such a way that the speed of the swirl does not change or that the amount of smoke generated is kept within an allowable range even if the speed of the swirl changes. The relationship shown in FIG. 13 is determined in advance by experiment or simulation and stored in the ECU 20. After the completion of the processing of step S202, the process proceeds to step S203.

In step S203, the degree of opening of the SCV 73 is adjusted. Specifically, the ECU 20 adjusts the degree of opening of the SCV 73 to the degree of opening determined in step S202. For example, the degree of opening of the SCV can be adjusted precisely by opening/closing the SCV 73 using a stepping motor. Moreover, for example, an opening degree sensor that measures the degree of opening may be provided for the SCV 73, and the degree of opening of the SCV 73 may be adjusted in such a way that the degree of opening of the SCV 73 measured by the opening degree sensor becomes equal to the degree of opening determined in step S202. After the completion of the processing of step S203, the process proceeds to step S204.

In step S204, fuel injection control and ignition time control are executed. Specifically, the pre-injection, ignition of the pre-injected fuel, and main injection are performed. The pre-injection, ignition of the pre-injected fuel, and main injection are performed in the manner described in the description of the above-described example. After the completion of the processing of step S204, this process is ended.

As described above, in this example, even if the engine speed changes, the change in the speed of the swirl can be kept small. Consequently, the burned gas region is located at substantially the same position at the time of main injection. Therefore, even when the engine speed changes, it is possible to prevent the main-injected fuel from entering the burned gas region, and the main-injected fuel can be burned at the presence of sufficient oxygen. In consequence, the generation of smoke can be reduced.

### REFERENCE SIGNS LIST

1: internal combustion engine
2: cylinder
3: piston
5: ignition plug
6: fuel injection valve
7: intake port
8: exhaust port
9: intake valve
10: exhaust valve

### 20: ECU

21: crank position sensor
22: accelerator position sensor
71: throttle
72: air flow meter
73: swirl control valve (SCV)
Tp: pre-injection time
Tm: main injection time
Ts: ignition time
Di: injection interval
Ds: ignition interval

1. An internal combustion engine having a combustion chamber in which a swirl or swirling flow about the center axis of its cylinder is generated, comprising:
a fuel injection valve having a plurality of injection ports and injecting fuel in directions from the center axis of the cylinder toward the wall of the cylinder;
an ignition plug whose position relative to said fuel injection valve is set in such a way that fuel spray injected through said fuel injection valve passes through an ignition-capable region and the ignition plug can ignite the fuel spray directly;
a controller configured to perform pre-injection, which is fuel injection performed through said fuel injection valve during the compression stroke, ignite pre-spray, which is fuel spray formed by the pre-injection, by said ignition plug, and thereafter perform main injection, which is fuel injection through said fuel injection valve performed at such a predetermined injection start time before the top dead center of the compression stroke that enables combustion to be started by flame of pre-injected fuel, thereby causing at least a portion of main-injected fuel to be burned by diffusion combustion,
wherein said fuel injection valve has a plurality of injection ports provided in such a way that the quantity of said main-injected fuel injected to a predetermined region that is defined by a predetermined angle equal to or smaller than 90 degrees about the fuel injection valve from the location of the ignition plug in the direction of rotation of the swirl is smaller than the quantity of said main-injected fuel injected to a region that is located adjacent to or apart from said predetermined region in the direction of rotation of the swirl, does not include the predetermined region, and is defined by an angle equal to said predetermined angle to have the same size as said predetermined region.

2. An internal combustion engine according to claim 1, wherein said fuel injection valve has no injection port that injects said main-injected fuel toward said predetermined region at the time of said main injection.

3. An internal combustion engine according to claim 1, wherein the size of an injection port of said fuel injection valve that injects said main-injected fuel toward said predetermined region at the time of said main injection is smaller than the size of an injection port of said fuel injection valve that injects said main-injected fuel toward a region other than said predetermined region at the time of said main injection.

4. An internal combustion engine according to claim 1, further comprising a swirl control valve provided in an intake passage of the internal combustion engine and capable of increasing the speed of the swirl in the cylinder of the internal combustion engine by decreasing the degree of opening,
wherein the higher the engine speed of the internal combustion engine is, the larger the degree of opening of said swirl control valve is made.

5. An internal combustion engine according to claim 1, wherein said predetermined region is a region in the combustion chamber in which burned gas of said pre-injected fuel is expected to exist at the time when said main injection is performed after the burned gas of said pre-injected fuel has been carried by the swirl.
